(19) United States
(12) Patent Application Publication
(10) Pub. No.: US 2019/0135469 A1
(43) Pub. Date: May 9, 2019

(54) Support Funnel

(71) Applicant: Alex Anderson, Boulder Creek, CA (US)

(72) Inventor: Alex Anderson, Boulder Creek, CA (US)

(21) Appl. No.: 15/804,030

(22) Filed: Nov. 6, 2017

(51) Int. Cl. B65B 39/00; B65B 39/06; B65B 1/04; A01G 9/08

(52) U.S. Cl. CPC B65B 39/007; A01G 9/081; B65B 1/04; B65B 39/06

(57) ABSTRACT

A support funnel for filling a grow bag starts as a flexible panel having a length and a height, with a first fastening region comprising a plurality of fastening elements, implemented along the height at a first end of the length of the flexible panel, and a second fastening region comprising a second plurality of fastening elements complementary to the first fastening elements, implemented along the height at a second end of the length of the flexible panel, opposite the first end. The flexible panel is rolled into a cylinder or cone shape, with the first fastening region overlapping the second fastening region, and the first fastening elements are engaged with the second fastening elements, providing a stable cylinder or cone, enabling insertion of the cylinder or cone into a grow bag to support the grow bag while filling same with soil.

### BACKGROUND OF THE INVENTION

### 1. Field of the Invention

The present invention is in the field of agricultural products and pertains particularly to methods and apparatus for filling grow bags with soil.

### 2. Discussion of the State of the Art

In the field of agriculture, containers used for planting have been provided in the form of fabric bags, termed grow bags in the art. Grow bags are available in a variety of diameters and heights deemed ideal, or at least appropriate for certain plants.

Grow bags may be fabricated from porous polypropylene fabric or polyethylene fabric, which allows for drainage from watering and aeration for the roots. Grow bags may be purchased as complete bags, or one may purchase the landscape or gardening fabric and may sew up their own custom grow bags. One issue with using grow bags in place of rigid soil containers or pots is that they are not able to hold shape while being filled, and often collapse in the filling process, at least partially, resulting in wasted soil and waisted time. Often two users are required to properly fill a grow bag with soil.

Therefore, what is clearly needed is a soil transfer apparatus and method of use thereof that eliminates the issues cited above.

### BRIEF SUMMARY OF THE INVENTION

In one embodiment of the invention a support funnel for filling a grow bag is provided, comprising a flexible panel having a length and a height, a first fastening region comprising a plurality of fastening elements, implemented along the height at a first end of the length of the flexible panel, and a second fastening region comprising a second plurality of fastening elements complementary to the first fastening elements, implemented along the height at a second end of the length of the flexible panel, opposite the first end. The flexible panel is rolled into a cylinder or cone shape, with the first fastening region overlapping the second fastening region, and the first fastening elements are engaged with the second fastening elements, providing a stable cylinder or cone, enabling insertion of the cylinder or cone into a grow bag to support the grow bag while filling same with soil.

In one embodiment, the support funnel further comprises handles engaging an upper extremity of the cone or cylinder shape, facilitating removal of the support funnel from the grow bag after filling the funnel and grow bag with soil. In one embodiment, the handles are disposed on opposite ends of a diameter of the cylinder or cone. In one embodiment, the handles are implemented in a manner to be attachable and removable. And in one embodiment the fastening elements comprise hook and loop fasteners.

In one embodiment, the fastening elements in the first fastening region comprise female openings in a matrix, and the fastening elements in the second fastening region comprise male extensions in a complementary matrix, enabling the male extensions to engage the female openings to fasten the fastening regions together. In one embodiment, the flexible panel is a metal sheet. In one embodiment, the flexible panel is formed of plastic. And in one embodiment the flexible panel is formed of a compostable polymer, that degrades over time into compost.

In another aspect of the invention a process for filling a grow bag is provided, comprising forming a flexible panel having a length and a height, with a first fastening region comprising a plurality of fastening elements, implemented along the height at a first end of the length of the flexible panel, and a second fastening region comprising a second plurality of fastening elements complementary to the first fastening elements, implemented along the height at a second end of the length of the flexible panel, opposite the first end, rolling the flexible panel into a cylinder or cone shape, with the first fastening region overlapping the second fastening region, engaging the first fastening elements with the second fastening elements, providing a stable cylinder or cone, and inserting the stable cylinder or cone into the grow bag, supporting the grow bag while being filled with soil.

In one embodiment, the process further comprises providing handles engaging an upper extremity of the cone or cylinder shape, facilitating removal of the support funnel from the grow bag after filling the funnel and grow bag with soil. In one embodiment the handles are disposed on opposite ends of a diameter of the cylinder or cone. In one embodiment, the handles are implemented in a manner to be attachable and removable. In one embodiment, the fastening elements comprise hook and loop fasteners. And in one embodiment the fastening elements in the first fastening region comprise female openings in a matrix, and the fastening elements in the second fastening region comprise male extensions in a complementary matrix, enabling the male extensions to engage the female openings to fasten the fastening regions together.

In one embodiment of the process the flexible panel is a metal sheet. In one embodiment, the flexible panel is formed of plastic. In one embodiment, the flexible panel is formed of a compostable polymer, that degrades over time into compost. And in one embodiment the process further comprises pulling the support funnel out of the grow bag after filling same with soil.

### BRIEF DESCRIPTION OF THE SEVERAL VIEWS OF THE DRAWINGS

FIG. 1 is a perspective view of a support funnel inserted into a grow bag according to an embodiment of the present invention.

FIG. 2 is a plan view of a support funnel in a rectangular shape unrolled.

FIG. 3 is a plan view of a trapezoidal support funnel unrolled.

FIG. 4 is an exploded cross-sectional view of fastening interface of support funnel fitted together to fix a specific diameter.

FIG. 5 is a plan view of a grow bag station supported by a wire base fixture in a semi-open position for mobile bag filling.

FIG. 6 is a block diagram depicting a mobile soil hopper filling a line of staged grow bags according to an embodiment of the invention.

### DETAILED DESCRIPTION OF THE INVENTION

In various embodiments described in enabling detail herein, the inventor provides a unique system and apparatus for filling fabric grow bags with soil and related materials. The material used to fill the grow bags may vary considerable in different circumstances, including soil, nutrients, fertilizers, and other materials. For the purpose of this document, the term soil is used to mean any and all of the combinations of ingredients that might be used to fill grow bags. The present invention is described using the following examples, which may describe more than one relevant embodiment falling within the scope of the invention.

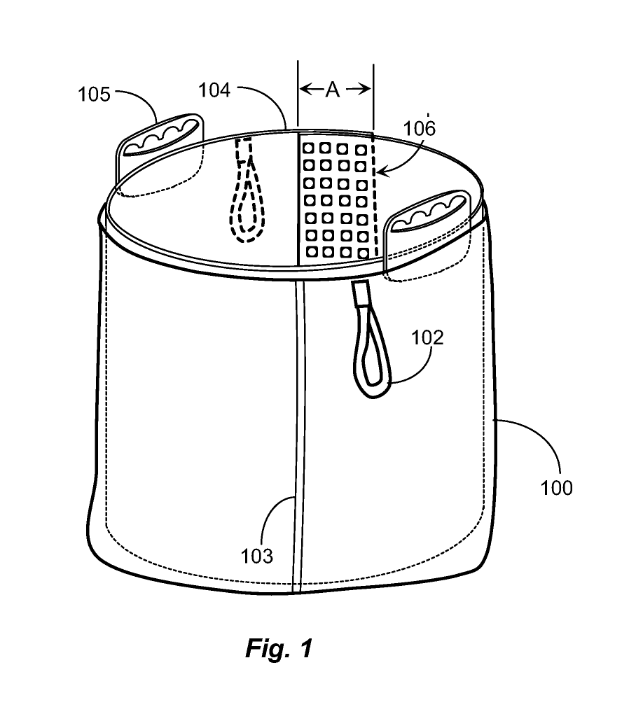

FIG. 1 is a perspective view of a support funnel 104 according to an embodiment of the invention, inserted into a grow bag 100. Grow bag 100 may be sewn or otherwise manufactured using an available landscape or gardening fabric such as polypropylene fabric or polyethylene fabric which allows for drainage from watering and aeration for the roots. Grow bags may also be purchased from various suppliers, and may vary somewhat in fabric and other features. Grow bag 100 in this example includes two or more sewn-on handles such as handle 102 enabling a user to pick the bag up and move it after it is filled. Grow bag 100 comprises in this example a vertical seam 103.

Grow bag 100 may vary widely in diameter and length, as such bags may be custom sewn, or manufactured of a standard size for growing an intended garden plant or tree. As described in the background section, grow bag 100 cannot, by itself, hold shape while a user is filling the bag with soil. Therefore, in one embodiment a support funnel 104 is provided for expanding the shape of grow bag 100 to a maximum diameter for filling the bag, and for supporting the bag in an open aspect as the bag is being filled.

Support funnel 104 may be manufactured from a resilient polymer material that may be available in a roll having a width dimension, and the roll may be of different lengths in different circumstances. Funnel 104 may also be manufactured from an organic plastic such as made from corn product. Other materials may be substituted if they are resilient and may expand to size when placed inside a grow bag.

Support funnel 104 is a rectangular sheet rolled over on itself and has overlapping edge flaps. In this example, the distance of overlap (one edge over another) is represented by arc A. Therefore, transfer funnel 104 may be cut or otherwise separated from the roll of material at a length A that exceeds the total circumference of bag 100 when full. Grow bag 104 in this example comprises a user snap interface 106 that may be provided as an upper funnel anchor point and/or a lower funnel anchor point. Interface 106 may contain form-fitted or molded features such as a rectangular seat of depression on side of the material followed by short annular post on the outward facing surface of the material enabling the sheet to overlap and be joined to itself, forming a cylinder.

Support funnel 104 in one embodiment includes at least two lifting handles 105 fixed thereto along an inside or outside edge, such that when the sheet is rolled over the grab handles are in opposing positions, enabling a user to pull funnel 104 up and out of grow bag 100 after filling the grow bag with soil. There may be more than two lifting handles provided without departing from the spirit and scope of the invention. Lifting handles 105 may be made of plastic and may be welded onto the surface of the sheet or may be formed as a contiguous part of the sheet. In one embodiment, the lifting handles are separate from the sheet that forms the funnel, and may be attached and removed by engaging snap elements. In this implementation, funnel 104 is fully inserted into and fixed at a point of expansion to hold the grow bag open while it is being filled. After filling, a user may pull the funnel out of grow bag 100 and reuse the funnel to expand a next grow bag for filling.

The height of funnel 104 is higher than the height of the grow bag, and the length of the sheet used to roll the funnel is longer that the circumference of the bag as depicted herein by dimension A (overlap). In general use of the invention, funnel 104 in sheet form may be rolled over to a diameter that is significantly smaller than the diameter of the bag opening and then inserted into the bag. The user may then release funnel 104 and let it expand to urge the bag fully open. The user may then fix the ends of the sheet forming the funnel together by press fitting the preformed snap features together at interface 106 at a diameter at or just under the maximum diameter of the bag. The user may then fill the bag with soil without the bag collapsing, and may remove the support funnel by handles 105.

In one implementation interface 106 may extend vertically the entire height of the funnel sheet at both ends while the rest of the sheet is smooth. In another implementation, the interface may extend deeper into the sheet or may be formed across the entire sheet without departing from the spirit and scope of the invention. In this implementation, the short annular posts of interface 106 are press fit or snapped into the rectangular seats or depressions enabling a user to fit the edges together to hold a fixed diameter for the funnel. However, other fastening mechanisms and hardware might be provided at the ends of the sheet to allow for attaching it together without departing from the spirit and scope of the invention. For example, the edges of funnel 104 may be fashioned with hook and loop interfaces as opposed to fastener features formed into the funnel sheet material.

In one implementation, a user may have a number of grow bags of a common diameter for filling. A solid sizing cylinder might be provided to enable creation of the correct diameter funnel that may then be used to fill the bags. In this case the sheet may expand within the solid cylinder before a user fastens the funnel at the correct diameter. In one implementation, a variety of sizing cylinders may be provided in different diameter corresponding with standard grow bag diameters. In such a circumstance, a pair of collars may be provided for each cylinder, the collars sized to fit over the rolled ends of the funnels to maintain the diameter of the funnel as set by the sizing cylinder.

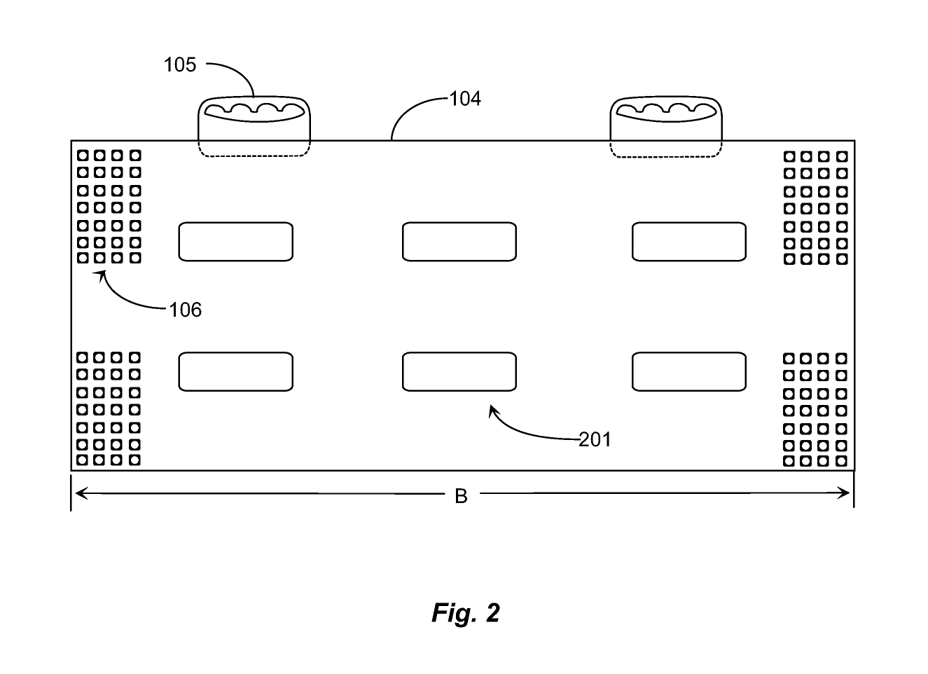

FIG. 2 is a plan view of rectangular support funnel 104 unrolled the rectangular profile. Interface regions 106 are formed at both ends of the sheet. In this implementation, there are four vertical rows indicating a possible position for affixing the sheet into a funnel for soil filling. A length dimension B of funnel 104 is sufficient to exceed the circumference of the object grow bag. Handles 105 are positioned to be disposed opposed to one another when the sheet is rolled into a cylinder.

A height dimension of the sheet is longer than the height of a grow bag it may be used to transfer soil into. In this implementation, there are a plurality of material relief openings 201 provided through the sheet material, the relief openings spaced apart along the sheet in two rows and three columns. Material relief openings 201 may allow soil to pass through the funnel and become displaced to the outside of the funnel between the inside of the grow bag and funnel material. This may allow for a reduced friction between the funnel and the grow bag when the funnel is to be pulled up and out of the grow bag by handles 105. In other implementations there are no such openings.

In this implementation the support funnel is unrolled as a rectangular sheet having four substantially parallel sides. This is not absolutely required to practice the present invention. In one implementation, the support funnel may be unrolled into the shape of a trapezoid and the edge of dimension B may be shorter than the top edge of the funnel. It will also be apparent to one with skill in the art that handles 105 may be separate from the funnel sheet but fixed thereto by welding, glue or fastening hardware, or may engage by snap elements. Handles 105 may also be formed in the material such that they are formed at the upper edge and proximate to the depicted handles. In this implementation, handles 105 include an ergonomic finger grip for user comfort while pulling funnel 104 from a filled grow bag.

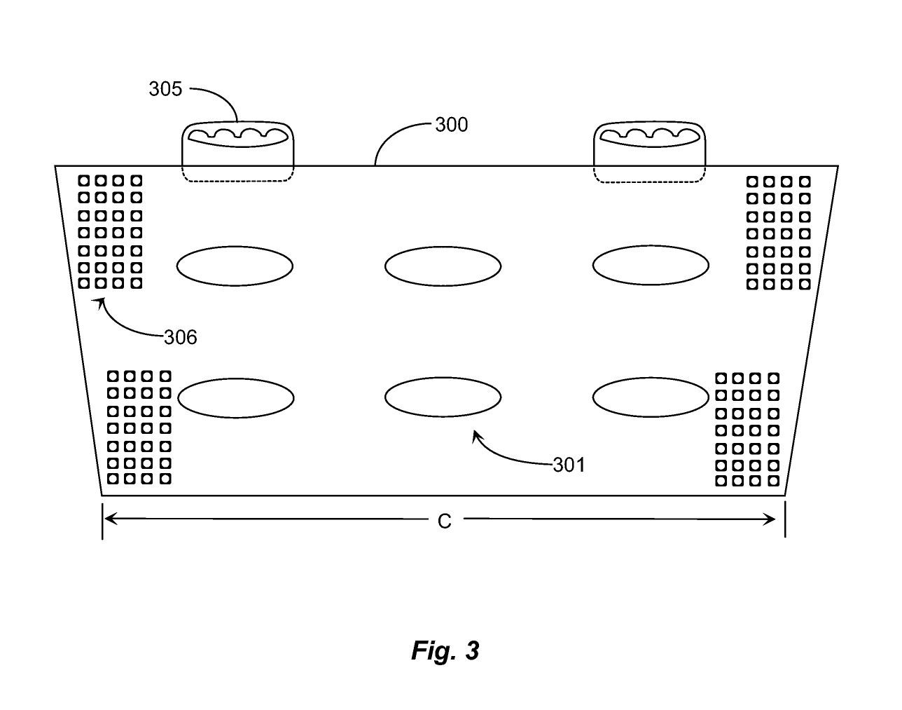

FIG. 3 is a plan view of a trapezoidal support funnel 300 unrolled. Support funnel 301 is shaped like a trapezoid having a shorter length dimension C at the bottom edge. The difference may be slight enough that the bottom opening of the funnel does not restrict support into the grow bag. In this implementation, fastener interfaces 306 are offset incrementally to enable fastening, though the edges of the funnel are slanted in toward the bottom forming a slight inverted cone structure. In such an implementation, the bottom diameter of funnel 300 rolled is smaller than the top diameter at the opposing edge. The smaller diameter may enable a user to more quickly insert funnel 300 into a next grow bag after it is rolled, expanded, and fixed within a first bag or a sizing cylinder.

In this implementation funnel 300 includes a plurality of relief openings 301 placed through the material in a similar fashion as described above for relief openings 201 funnel 104 depicted unrolled in FIG. 2. In this implantation, the relief openings are elliptical rather than rectangular is shape but serving the same function of allowing soil to pass through the funnel to between the funnel and inside wall of the bag to reduce friction. In one implementation, the lower edge of funnel 300 may not be a straight edge but rather a concave edge, for example because of removing material to further reduce surface area of the funnel. There a variety of possible shape profiles beyond rectangular or trapezoidal such as elliptical, for example.

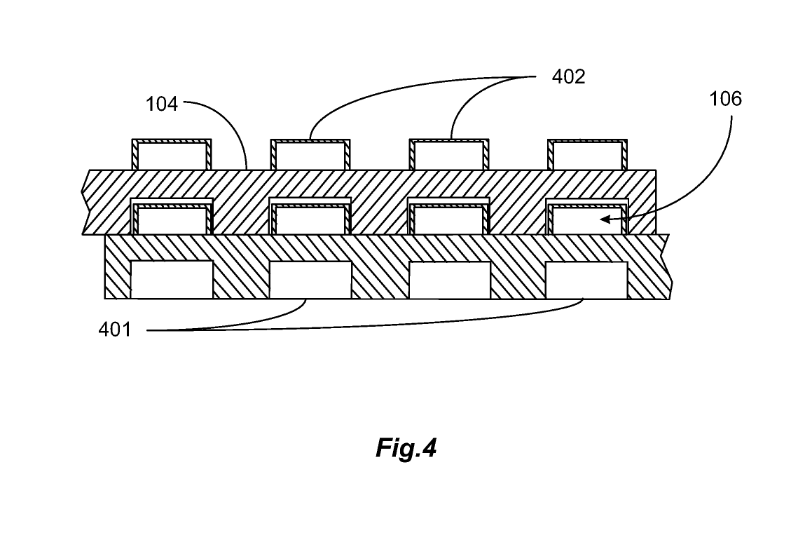

FIG. 4 is an exploded cross-sectional view of fastening interface 106 of support funnel 104 fitted together to fix a diameter. Interface 106 is depicted in the center between the overlapping ends of funnel 104 in a rolled state. The curvature is not reproduced in this example for the sake of simplicity but may be assumed present based on the fixed diameter of the funnel.

Snap recesses 401 are provided on one side of the funnel sheet material. In this implementation, the recesses are square and have a width dimension and a depth dimension into the material. On the opposite side of the funnel sheet material at interface 106 are annular snap posts 402. Posts 402 are aligned in a strategic pattern matching that of the snap recesses such that they occupy the fame footprint in the material. Posts 402 may be separately molded onto a strip of polymer that may be laminated onto or otherwise adhered to the surface of the funnel sheet at the location of the interface.

Posts 402 are hollow in this example, but may also be solid posts. In one implementation, posts 402 may be heat punched or stamped through the funnel sheet from the side of the snap recesses wherein the punch pushes the post material into a post mold plate having annular recesses provided therein for accepting the material. Snap recesses 401 are just wider in dimension from wall to wall than the diameter of the posts. The shared height of posts 402 is just smaller than the shared depth of the fastener recesses enabling full insertion without bottoming out within the recess. When the ends are overlapped at interface 106, snap posts 402 may be pressed into snap recesses 401 to lock the support funnel into a fixed diameter for grow bag filling. In this example, funnel 104 may be rolled up in either clockwise or counter clockwise direction. The shapes of the fastener components, more particularly, recesses 401 and posts 401 may be inverted or a combination of other shapes might be used instead.

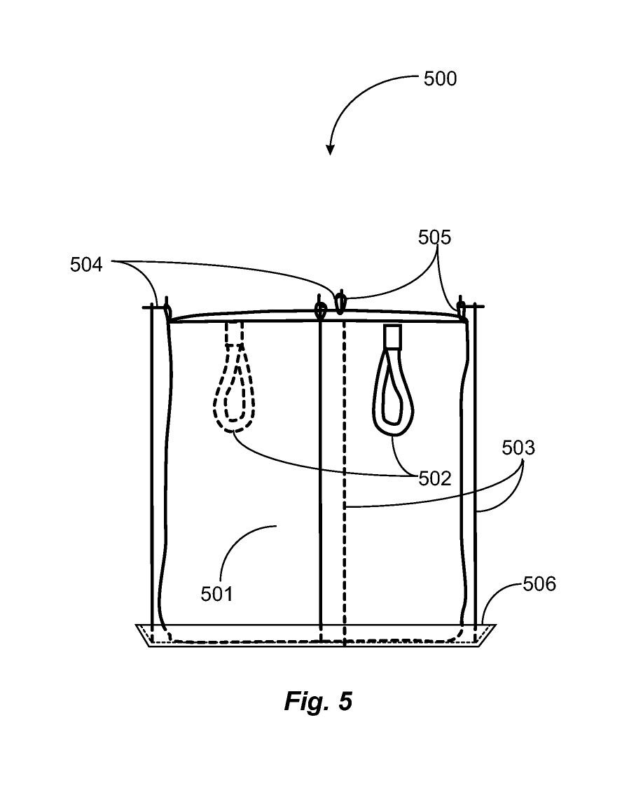

FIG. 5 is a plan view of a grow bag station 500 supported by a wire base fixture 506 in a semi-open position for mobile bag filling. In this implementation station 500 includes a grow bag 501 similar in many aspects to grow bag 100 of FIG. 1 with a few alterations. Grow bag 501 is positioned over a base 506 in a semi open position. Base 506 may be in the form of a shallow dish open at the top as is depicted herein. The diameter of the base is sufficient to cover the diameter of the grow bag and may function to trap draining water and to prevent the grow bag material for contact with a raw surface such as un-worked ground.

Base 506 may include three or more vertical rods 503 that may be fastened or attached to base plate 506 such as by providing tapped holes in the surface wall of the plate and providing matching male threads at the ends of the wires that may be threaded into the base. Rods 503 are stiff in nature and may extend vertically up from base 506 to a height just greater than the height of the grow bag. Each rod includes a hangar pin 504 welded to the upper end that provides a hang point to attach the grow bag top thereto via sewn loops provided at the top for the purpose. In this implementation, there are four wires symmetrically spaced apart and four loops 505 similarly strategically spaced to enable hanging the portions of the empty grow bag to keep it at least partially open.

Base 506 may be adapted for forklift or dolly transport after bag 501 is filled with soil. Several grow bags might be staged, such as at a grow site in this fashion wherein a user may insert a funnel into the first bag, let it expand to the inside bag diameter, and fix the funnel at the correct funnel diameter to enable filling and removal of the funnel and reinsertion of the funnel into a next staged grow bag for subsequent filling of that grow bag. In one implementation, the rods in the base fixture may be removed after filling and stowed as the full bag with plant no longer requires vertical support. Base 506 may also be removed and stowed or left under the grow bag for the season to trap draining water and to protect the grow bag fabric from raw ground.

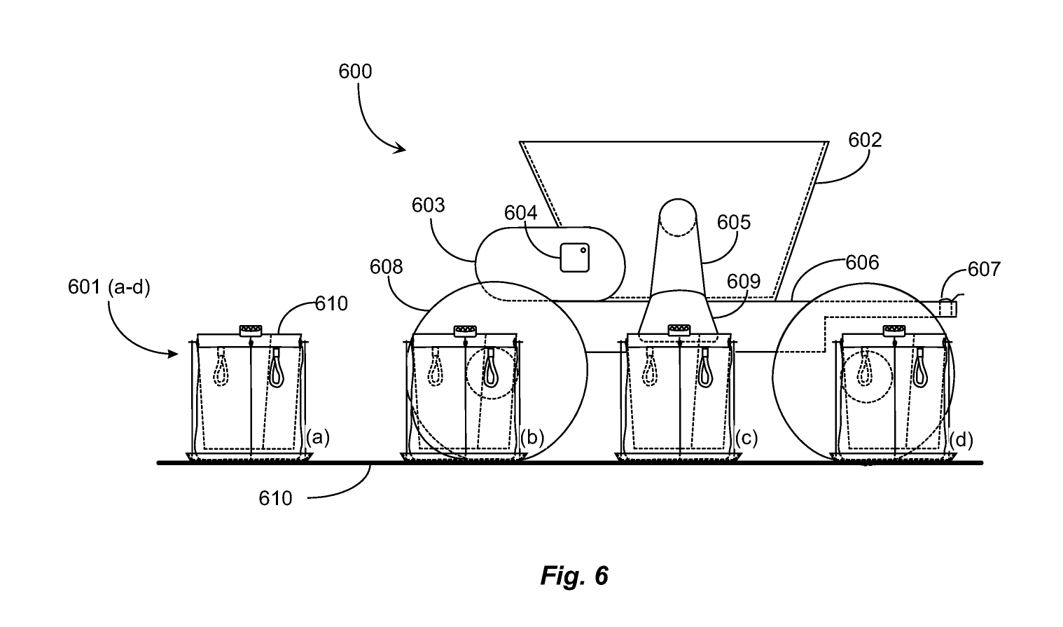

FIG. 6 is a block diagram depicting a mobile soil hopper 600 filling a line of staged grow bags according to an embodiment of the invention. Hopper 600 may be a soil transfer machine that may be towed by a vehicle. Hopper 600 has a soil tank 602 supported by a flatbed style or rail style body 606 having axle-mounted wheels 608 and having a tow end as depicted herein by a ball tow seat 607. Hopper 600 supports a generator 603 with a user accessible switch panel 604 (start stop) for moving the soil within tank or bin 602 via conveyor, fluted shaft, other mechanics out through a transfer tube 605 and through a spread head 609 for even distribution into the bags.

In this implementation, grow bags 601a through d, are staged onto rod base fixtures in a line at a grow site. Each bag 601 is supported in a semi-open position by the rods of the fixture as depicted in FIG. 5 above. Referring to grow bag 601a, a support funnel 610 is inserted and fixed to a diameter suitable for filling grow bag 601a with soil.

In one implementation, support funnel 610a may be in the form of a trapezoidal funnel like funnel 300 depicted in and described with reference to FIG. 3. In such a case, the diameter of the bottom portion of funnel 610 is smaller than the top edge diameter by an amount facilitating more simple insertion of the funnel into a next bag of the same dimensions.

A user may walk along the hopper machine parallel to the grow line and may expand and lock the funnel for a first time in a first grow bag such as grow bag 601a. The user may let the hopper fill the bag through the inserted funnel and when full, the hopper may begin rolling over to the next bag in line. The user may follow the hopper down the line having pulled funnel 610 out of the last grow bag and inserted into the next grow bag 610b . When bag 610b is full the user may grab the funnel, and carry it to and insert it into a next grow bag 601c that is currently being filled. In this view, each bag depicted has a support funnel inserted.

In one implementation, the funnel sheet material may be adapted to compost in a bag filled with soil that is watered. Compostable polymers have resilient properties and can be used to expand the grow bag. Compostable polymer is made from corn starch and other plant resins such as soy bean protein, potato starch and cellulose or a combination thereof. In such an embodiment handles for pulling the funnel out of the bag will not be required. In another implementation, there are a plurality of funnels, such as four in this embodiment, where grow bags 601a-d are in a line or row. As the hopper moves past a user may transfer each diameter-locked funnel to a grow bag in a next row and so on for a grow site containing many rows of grow bags. If a sizing cylinder is available a user may prepare a plurality or desired number of funnels for use in staging and then transferring as grow bags are filled.

It may be noted herein for a funnel that is compostable, it may be a rectangular as opposed to a trapezoidal funnel due to the smaller diameter at the bottom of the bag. In one implementation line 610 may represent a moving conveyor surface that may be part of a continuous soil transfer filling station where instead of a mobile transfer vehicle 600 the soil transfer apparatus is a fixed soil transfer machine that may be continually fed soil at one end for transfer into grow bags passing under the transfer tube. In such an implementation bags on base fixtures may be unloaded after filled and trucked to any local or regional grow site in a state ready for planting or plant transfer from such as a smaller bag or starter container to a larger bag for continued growth.

In one aspect of the invention support funnels may be manufactured from a relatively long, continuous roll of polymer material, by feeding material from the roll through dies and cutters that form the elements of the funnel as the material passes, and then cuts the material to provide funnel sheets of proper length for a particular object grow bag.

It will be apparent to one with skill in the art that the soil transfer system of the invention may be provided using some or all the mentioned features and components without departing from the spirit and scope of the present invention. It will also be apparent to the skilled artisan that the embodiments described above are specific examples of a single broader invention that may have greater scope than any of the singular descriptions taught. There may be many alterations made in the descriptions without departing from the spirit and scope of the present invention.

It will be apparent to the skilled person that the arrangement of elements and functionality for the invention is described in different embodiments in which each is exemplary of an implementation of the invention. These exemplary descriptions do not preclude other implementations and use cases not described in detail. The elements and functions may vary, as there are a variety of ways the hardware may be implemented and in which the software may be provided within the scope of the invention. The invention is limited only by the breadth of the claims below.

1. A support funnel for filling a grow bag, comprising:
a flexible panel having a length and a height;
a first fastening region comprising a plurality of fastening elements, implemented along the height at a first end of the length of the flexible panel; and
a second fastening region comprising a second plurality of fastening elements complementary to the first fastening elements, implemented along the height at a second end of the length of the flexible panel, opposite the first end;
wherein the flexible panel is rolled into a cylinder or cone shape, with the first fastening region overlapping the second fastening region, and the first fastening elements are engaged with the second fastening elements, providing a stable cylinder or cone, enabling insertion of the cylinder or cone into a grow bag to support the grow bag while filling same with soil.

2. The support funnel of claim 1 further comprising handles engaging an upper extremity of the cone or cylinder shape, facilitating removal of the support funnel from the grow bag after filling the funnel and grow bag with soil.

3. The support funnel of claim 2 wherein the handles are disposed on opposite ends of a diameter of the cylinder or cone.

4. The support funnel of claim 2 wherein the handles are implemented in a manner to be attachable and removable.

5. The support funnel of claim 1 wherein the fastening elements comprise hook and loop fasteners.

6. The support funnel of claim 1 wherein the fastening elements in the first fastening region comprise female openings in a matrix, and the fastening elements in the second fastening region comprise male extensions in a complementary matrix, enabling the male extensions to engage the female openings to fasten the fastening regions together.

7. The support funnel of claim 1 wherein the flexible panel is a metal sheet.

8. The support funnel of claim 1 wherein the flexible panel is formed of plastic.

9. The support funnel of claim 1 wherein the flexible panel is formed of a compostable polymer, that degrades over time into compost.

10. A process for filling a grow bag, comprising:
forming a flexible panel having a length and a height, with a first fastening region comprising a plurality of fastening elements, implemented along the height at a first end of the length of the flexible panel, and a second fastening region comprising a second plurality of fastening elements complementary to the first fastening elements, implemented along the height at a second end of the length of the flexible panel, opposite the first end;
rolling the flexible panel into a cylinder or cone shape, with the first fastening region overlapping the second fastening region;
engaging the first fastening elements with the second fastening elements, providing a stable cylinder or cone; and
inserting the stable cylinder or cone into the grow bag, supporting the grow bag while being filled with soil.

11. The process of claim 10 further comprising providing handles engaging an upper extremity of the cone or cylinder shape, facilitating removal of the support funnel from the grow bag after filling the funnel and grow bag with soil.

12. The process of claim 11 wherein the handles are disposed on opposite ends of a diameter of the cylinder or cone.

13. The process of claim 11 wherein the handles are implemented in a manner to be attachable and removable.

14. The process of claim 10 wherein the fastening elements comprise hook and loop fasteners.

15. The process of claim 10 wherein the fastening elements in the first fastening region comprise female openings in a matrix, and the fastening elements in the second fastening region comprise male extensions in a complementary matrix, enabling the male extensions to engage the female openings to fasten the fastening regions together.

16. The process of claim 10 wherein the flexible panel is a metal sheet.

17. The process of claim 10 wherein the flexible panel is formed of plastic.

18. The process of claim 10 wherein the flexible panel is formed of a compostable polymer, that degrades over time into compost.

19. The process of claim 10 further comprising pulling the support funnel out of the grow bag after filling same with soil.
